(19) United States
(12) Patent Application Publication
(10) Pub. No.: US 2005/0266259 A1
(43) Pub. Date: Dec. 1, 2005

(54) AWARD APPARATUS AND METHOD OF MAKING AN AWARD

(76) Inventor: Mark L. Layton, Orem, UT (US)

Correspondence Address: RADER, FISHMAN & GRAUER PLLC, RIVER PARK CORPORATE CENTER ONE, 10653 S. RIVER FRONT PARKWAY SUITE 150, SOUTH JORDAN, UT, 84095, US

(21) Appl. No.: 10/454,277

(22) Filed: Jun. 3, 2003

(51) Int. Cl. B32B 9/06

(52) U.S. Cl. 428/542.4

(57) ABSTRACT

An award apparatus includes a second member coupled to a first member, wherein the second member is another award that is configured to be worn separately. A portion of the second member may include a display depicting at least the first member. A method for making an award includes providing a first member and connecting a second member to the first member, wherein the second member is another award that is configured to be worn separately. The method may also include displaying on the second member a depiction of at least a portion the first member.

### FIELD

This application relates to awards and methods of making awards. More particularly, this application concerns novel structures for statues, trophies and medals used as awards.

### BACKGROUND

It is commonly known to provide trophies including statues to participants in various types of contests and competition. Such statues may be mounted on a base having an engraved message with information about the contest and the type of award being given.

Statues used for trophies often depict a figure of one or more persons. In some instances, the figures depict likenesses of participants in a contest. Examples are shown in U.S. Design Pat. 293,221 and U.S. Pat. No. 5,322,739, in which football players and a golfer are depicted in action. Other such trophies may depict an object that is a part of the contest, such as in U.S. Design Pat. 321,842 showing a sailboat and U.S. Pat. No. 5,853,823 depicting a soccer ball.

Statues sometimes show inspiring, fictional or romantic figures that are meant to inspire, educate or stimulate imagination, rather than to depict a specific person or individual. An example is given in U.S. Design Pat. 312,058 showing an angel figurine. Often, a statute will depict a person in a heroic stance or depict a situation that is exaggerated in a heroic manner, again to inspire or depict excellence in some achievement.

Medallions are also commonly awarded to participants in various types of contests. Such medallions may be provided with a chain, ribbon or other means for attaching the medallion around the neck or on the lapel of the recipient. In some instances, such medallions show various figures or objects related to the contest in point. An example is shown in U.S. Design Pat. 285,183, showing a medallion with various sports objects thereon.

### SUMMARY

The present application discloses a statue that may be awarded as a trophy for winning or showing excellence in competition. In addition, the statue of the present application includes a medallion supported by the statue that is indicative of a medallion that may be awarded in connection with competition. Further, the medallion may include a depiction of the statue supporting the medallion.

In one instance disclosed herein, the award comprises a first member, and a second member coupled to the first member, wherein the second member represents another award that may be worn separately.

In another embodiment, an award is provided that comprises a first member and a second member coupled to the first member, wherein a portion of the second member includes a display depicting at least the first member.

A method is also provided for making an award, comprising providing a first member, and connecting a second member to the first member, wherein the second member represents another award that may be worn separately.

In another instance, a method is provided for making an award comprising providing a first member, providing a second member connected to the first member, and displaying on the second member a depiction of at least a portion the first member.

Other aspects and advantages of the present invention will become apparent from the following detailed description, which in conjunction with the accompanying drawings illustrates by way of example the principles of the present invention.

### BRIEF DESCRIPTION OF THE DRAWINGS

FIG. 1A is a front view of one implementation of the award;

FIG. 1B is a front exploded view of FIG 1A;

FIG. 2 is a side view of the award of FIG. 1;

FIG. 3 is a side view of the award of FIG. 1 as seen from the opposing side of the view depicted in FIG. 2;

FIG. 4 is a rear view of the award of FIG. 1;

FIG. 5 is an overhead view of the award of FIG. 1; and

FIG. 6 is a perspective view of the award of FIG. 1.

### DETAILED DESCRIPTION

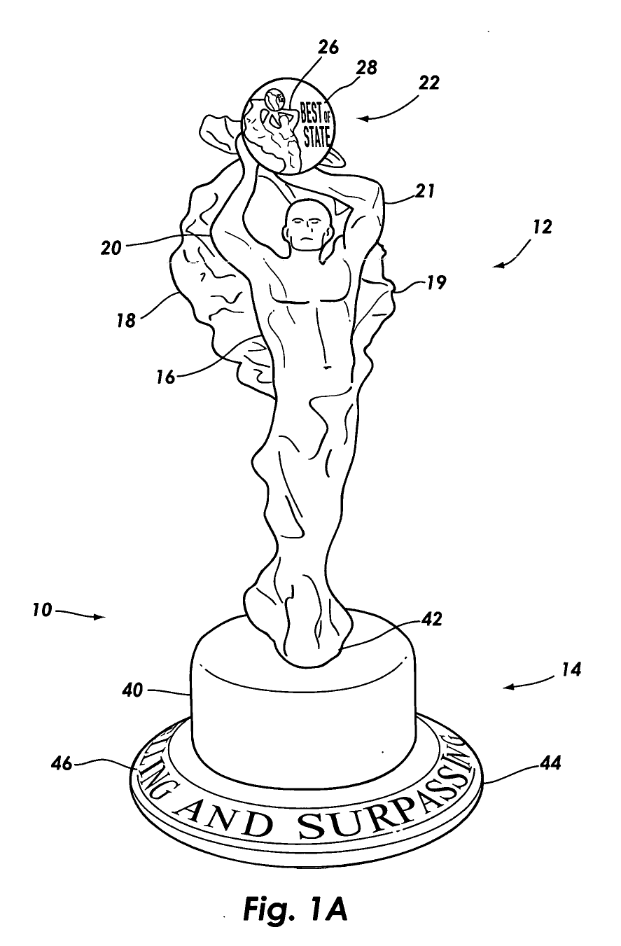

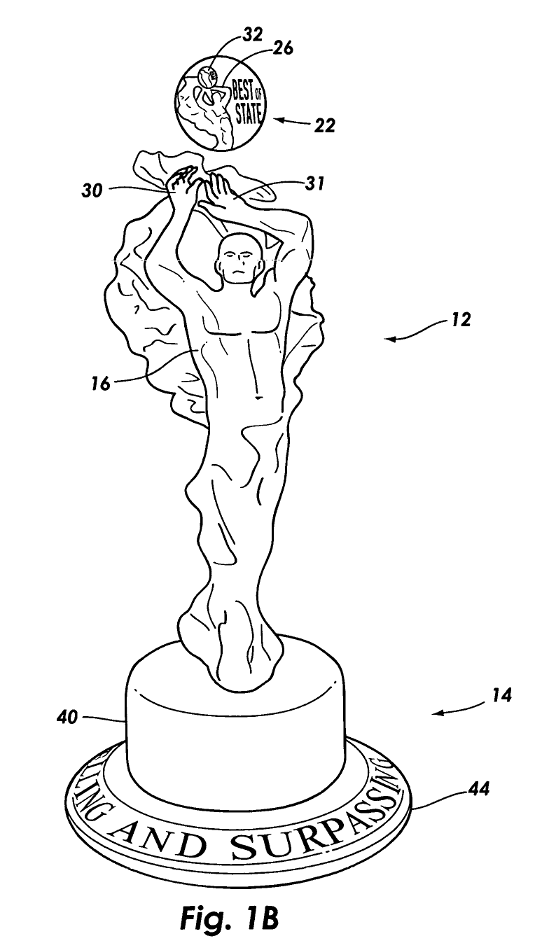

Referring now to FIG. 1A, one implementation of a trophy or award 10 is given, showing a statue 12 mounted on a base 14. The statue depicts a heroic male FIG. 16 having wings 18 and 19 extending behind the FIG. 16. Statue FIG. 16 has his arms 20 and 21 uplifted to support a round coin-shaped medallion portion 22 above his head. Medallion portion 22 is supported so as to display the surface of the medallion 22, having a depiction 26 of the statue FIG. 16 with the medallion 20 shown on the medallion surface. The medallion may also depict words or slogans 28 representative of the competition involved with the trophy or award 10.

The medallion 22 may further represent a separate medallion that can be awarded to participants in the relevant competition or contest. For clarity, FIG. 1B shows an exploded view of FIG. 1A, in which the medallion portion 22 has been separated from the hands 30 and 31 of the statue FIG. 16. If desired, the medallion portion 22 may be worn separately from the FIG. 16. Further, the medallion portion 22 may iteratively include a depiction of at least a portion of the combination of the statue FIG. 16 and the medallion portion 22. Although not clearly shown in FIG. 1B, the statue depiction 26 may further include second depiction 32, again showing a statue figure with medallion, thus depicting another iteration. Successive iterations may be depicted as desired. In addition, a separate medallion or medallions (not shown) similar to the medallion coupled to the statue may be awarded separately.

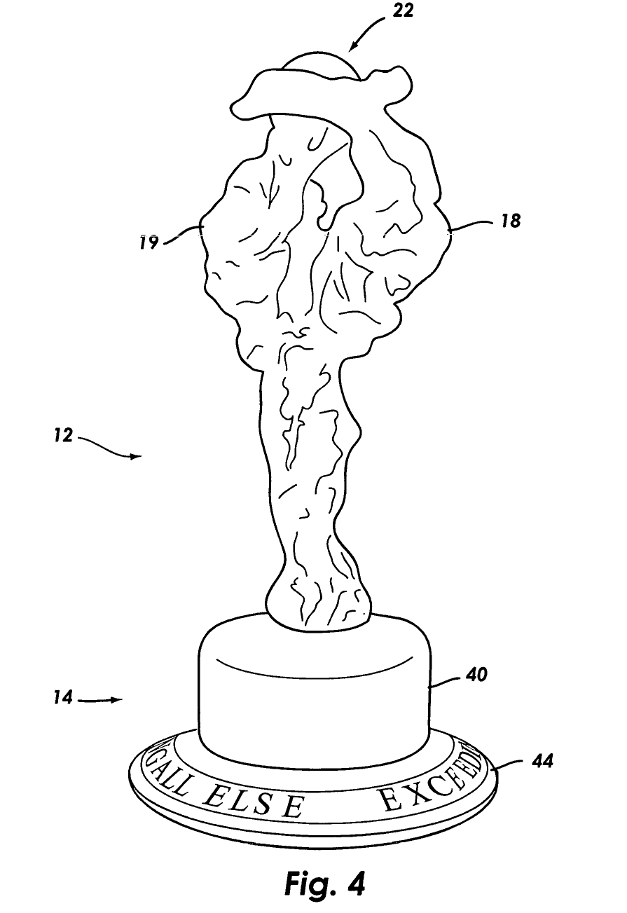

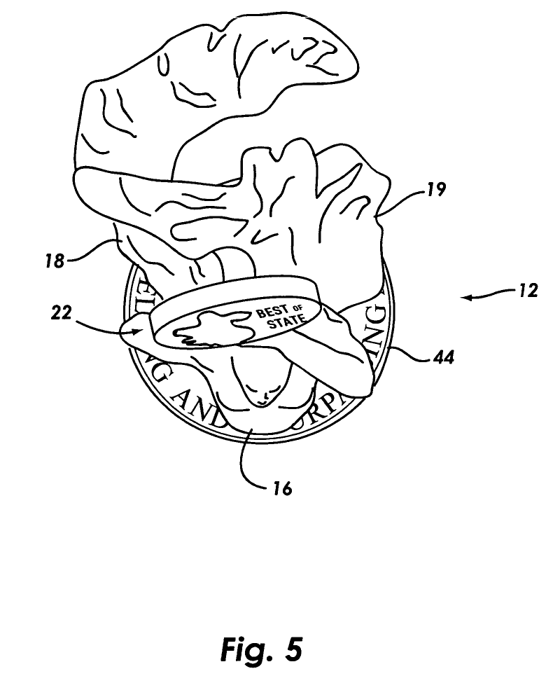

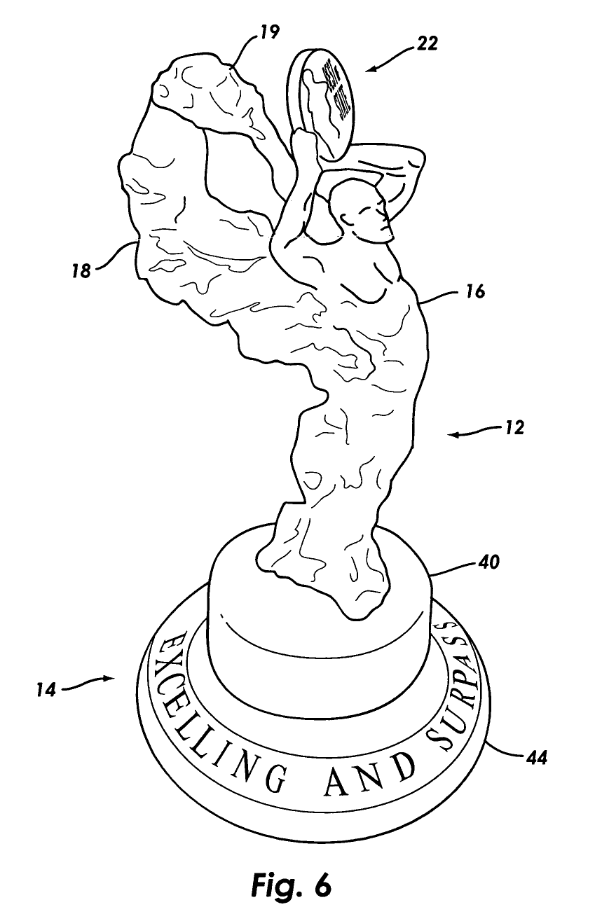

As seen in FIGS. 1-6, the statue 12 includes a base 14, having a pedestal 40 coupled to the base bottom 42 of FIG. 16. A broad circular support footing 44 is connected to the bottom of pedestal 40. Selected wording 46 is inscribed or embossed on the surface of the footing 44.

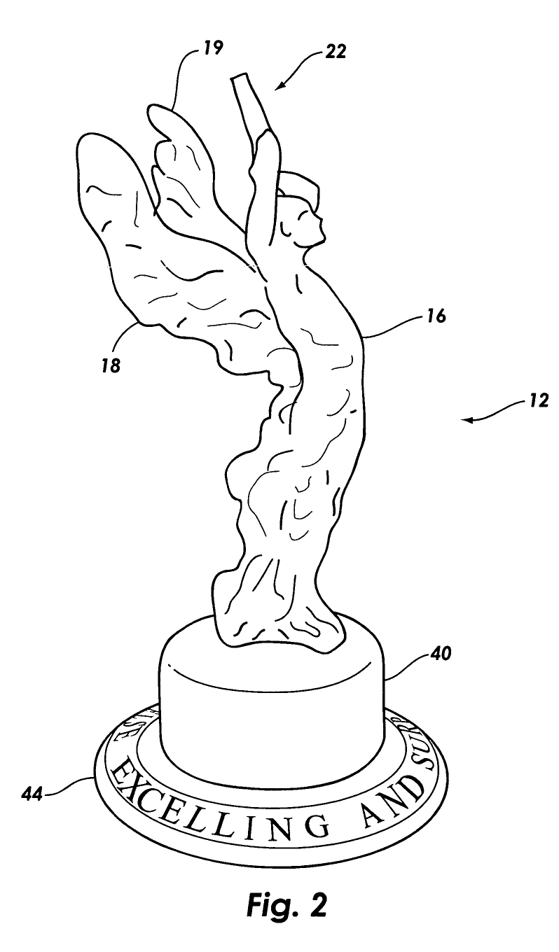

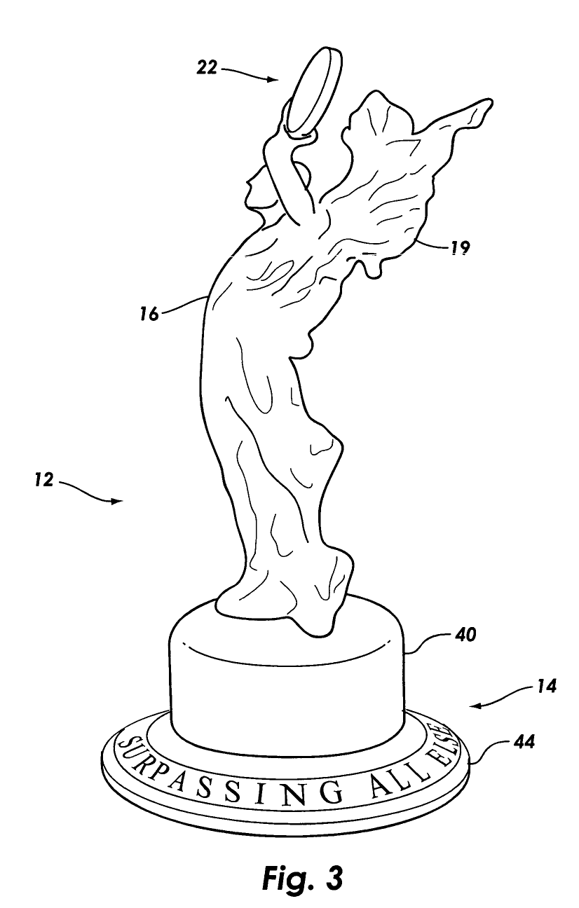

As shown in the figures, statute 12 is three-dimensional object, so that wings 18 and 19 extend behind FIG. 16. Medallion portion 22 may also be angled relative to FIG. 16, as best seen in FIGS. 2 and 3.

Although the above embodiments are representative of the present invention, other embodiments will be apparent to those skilled in the art from a consideration of this specification and the appended claims, or from a practice of the embodiments of the disclosed invention. It is intended that the specification and embodiments therein be considered as exemplary only, with the present invention being defined by the claims and their equivalents.

1. An award, comprising:
a first member, and
a second member coupled to the first member, wherein the second member another award configured to be worn separately, said first member being a statue and said second member being a medallion.

2-3. (canceled)

4. The award of claim 1, wherein the second member is configured to be worn separately.

5. The award of claim 1, wherein the second member is removably coupled to the first member.

6. The award of claim 1, wherein the second member is fixedly coupled to the first member.

7. An award, comprising:
a first member, and
a second member coupled to the first member, wherein a portion of the second member includes a display depicting at least the first member, said first member being a statue and said second member being medallion.

8. The award of claim 7, wherein the display depicts the first member coupled to the second member.

9. The award of claim 8, wherein the display depicts the second member further displaying the first member coupled to the second member.

10-11. (canceled)

12. The award of claim 7, wherein the second member is configured to be worn separately.

13. The award of claim 7, wherein the second member is removably coupled to the first member.

14. The award of claim 7, wherein the second member is fixedly coupled to the first member.

15. A method of making an award, comprising:
providing a first member, and
connecting a second member to the first member, wherein the second member another award configured to be worn separately, said fist member being a statue and said second member being a medallion.

16. The method of claim 15, farther comprising removably coupling the second member to the first member.

17. (canceled)

18. A method of making an ward, comprising:
providing a first member,
providing a second member connected to the first member, and
displaying on the second member a depiction of at least a portion the first member, said first member being a statue and said second member being a medallion. cm 19. The method of claim 18, further comprising displaying on the second member a depiction of the first member coupled to the second member.

20. The method of claim 19, further comprising displaying on the depiction of the second member a further depiction of the first member coupled to the second member.
